(19) United States
(12) Patent Application Publication
(10) Pub. No.: US 2017/0019969 A1
(43) Pub. Date: Jan. 19, 2017

(54) AC LED LIGHT ENGINE

(71) Applicant: EPtronics, Inc., Gardena, CA (US)

(72) Inventors: Tom O'Neil, Torrance, CA (US); Lee Chiang, Sylmar, CA (US)

(21) Appl. No.: 14/925,765

(22) Filed: Oct. 28, 2015

Related U.S. Application Data
(60) Provisional application No. 62/194,033, filed on Jul. 17, 2015.

(51) Int. Cl. H05B 33/08

(52) U.S. Cl. CPC H05B 33/0842; H05B 33/083; H05B 33/0809

(57) ABSTRACT

A light engine driven directly from the AC power line has multiple series connected arrays of LEDs each with an associated current limiting transistor. The current from each current limiting transistor goes through a corresponding current sensing resistor and all these resistors are connected in series. The voltage across each current limiting transistor is applied across the next LED array so that as the voltage increases during the power line cycle, the next array becomes activated by the increasing voltage across the previous current limiting transistor. When this happens the previous current limiting transistor is turned off. This continues until all the arrays are activated at the peak of the line, at which point the array current is controlled by the last current limiting transistor.

The present invention claims priority from and is a non-provisional of U.S. provisional application No. 62/194,033 entitled AC Led Driver In Constant Current Mode by inventors Thomas O'Neil and Lee Chiang, filed Jul. 17, 2015 the disclosure of which is incorporated herein by reference.

### FIELD OF THE INVENTION

The field of the present invention is direct AC powered LED light engines in which the LEDs are all in series and are driven with a nearly constant current.

### BACKGROUND TO THE INVENTION

It has become conventional in LED light engines which are to be driven directly from the rectified AC power line to arrange all the LEDs in series so that their forward voltage is just a little less than the peak of the AC line voltage. The current which passes may be limited by resistors or analog circuit current limiters. Such a circuit will only pass current at the peak of the AC power line, leading to the product having a poor power factor and high current harmonic distortion. This situation is routinely improved by incorporating switches so that when the AC power line voltage is less than its peak value, closing a switch shorts out some of the LEDs so that a lesser forward voltage is presented to the power line, allowing current to flow during a larger fraction of the power line voltage cycle and thus improving the power factor and total harmonic distortion (THD).

Obviously, this effect can be improved upon by dividing the LED string into multiple subsections so that almost continuous current flow can take place through the LEDs. In practice, three or four subsections of the LED strings are routinely used to piece together an AC line current waveform which is an approximation to a sine wave. This general principle is widely used. A representative example of the prior art is US patent application 2013/0026924 by Jong published Jan. 31, 2013, entitled LED Driving Circuit Package, the disclosure of which is incorporated herein by reference. Jong's block diagram is shown as prior art FIG. 1. The LED string is divided into four subsections, and a switchable current source is provided for each LED subsection. All the switchable current sources bypass the current directly back to the negative terminal of the bridge rectifier. A voltage detection circuit determines which part of the line voltage cycle is current, and then current sensing logic uses this information to determine when to operate the current limiters on and off. The disadvantage of this circuit is that it requires an elaborate digital current comparison circuit which turns the current limiters on and off at the right time.

Another example of a light engine in which switches are applied across LEDs to match the LED voltage to the varying line voltage is U.S. Pat. No. 8,373,363 by Gradjcar entitled Reduction of Harmonic Distortion For LED Loads, issued Feb. 12, 2013, the disclosure of which is incorporated herein by reference. See for example FIG. 39 of Gradjcar. The Gradjcar circuit senses the current passing through the LED string, and turns the bypass switches off one by one as the current rises until all the LEDs are simply connected across the power line at the peak of the line voltage cycle. The problem with Gradjcar's approach is that there is almost no current limiting, so that if the power line voltage increases the LED current will increase rapidly and without limit.

In US patent application 20120081009 by Shteynberg, entitled Apparatus, Method and System for Providing AC Line Power to Lighting Devices issued Apr. 5, 2012, the disclosure of which is incorporated herein by reference. Shteynberg introduces current limiting, which renders the circuit capable of coping with varying voltage levels, however each LED segment has its own independent current sensing resistor and all these resistors are connected in parallel back to the negative terminal of the bridge rectifier. Without any interaction, each of these channels acts independently and so a complex digital control circuit is needed to orchestrate which switch turns on at which current. China invention patent CN 103188848A by Wang, Qin Heng entitled Segmented Linear Constant Current Light Emitting Diode (LED) Driving Circuit published Jul. 3, 2013, the disclosure of which is incorporated herein by reference, describes a multi element LED string light engine with switches and mentions constant current operation, but does not show any connection between the switches and the negative terminal of the bridge rectifier.

From the foregoing it is apparent that there is a need for an AC LED light engine which has simple analog current limiters which are applied to each LED segment in turn and operate to inherently draw a sinusoidal current from the AC power line without using any complex digital circuitry to switch the current limiters on and off. Such a light engine will generate essentially no emi/rfi, and will be low in cost.

### SUMMARY OF THE INVENTION

A light engine is described which uses a bridge rectifier to convert the AC power line voltage into a series of unidirectional half sine wave voltage pulses. Connected to the positive output terminal of the bridge rectifier is a string of LEDs, all connected anode to cathode, which are subdivided into multiple substrings and each substring has an analog current limiter connected between its cathode and the end of a string of current sense resistors. The string of current sense resistors is itself subdivided into substrings, all connected end to end, with the final resistor connected back to the negative terminal of the bridge rectifier. Each sense resistor substring controls the current through a corresponding analog current limiter. The placing of these sense resistors in series is an important feature of the invention because when each subsequent LED substring commences conducting, its current also goes through the sense resistor corresponding to the previous substring. This excessive current thus forces the current limiter for the previous substring to shut off completely. In this way each current limiter in turn is enabled and then automatically shut off as its successor is activated. Finally at the peak of the AC line voltage waveform only the current limiter for the last LED segment is operating and is regulating the current through the whole string. As the line voltage waveform declines from the peak, the situation reverses with each current limiter first operating at constant current and then switching to full on until at the line voltage zero crossing all the current limiters are fully on ready for the next half cycle. This arrangement is advantageous because the current through the LEDs is constant, avoiding extreme currents associated with voltage surges. Also the control circuitry is minimal and simplistic comprising only one quad op amp chip.

### BRIEF DESCRIPTION OF THE DRAWINGS

FIG. 1 is a typical prior art light engine using a plurality of LED strings each with a switch and a constant current regulator.

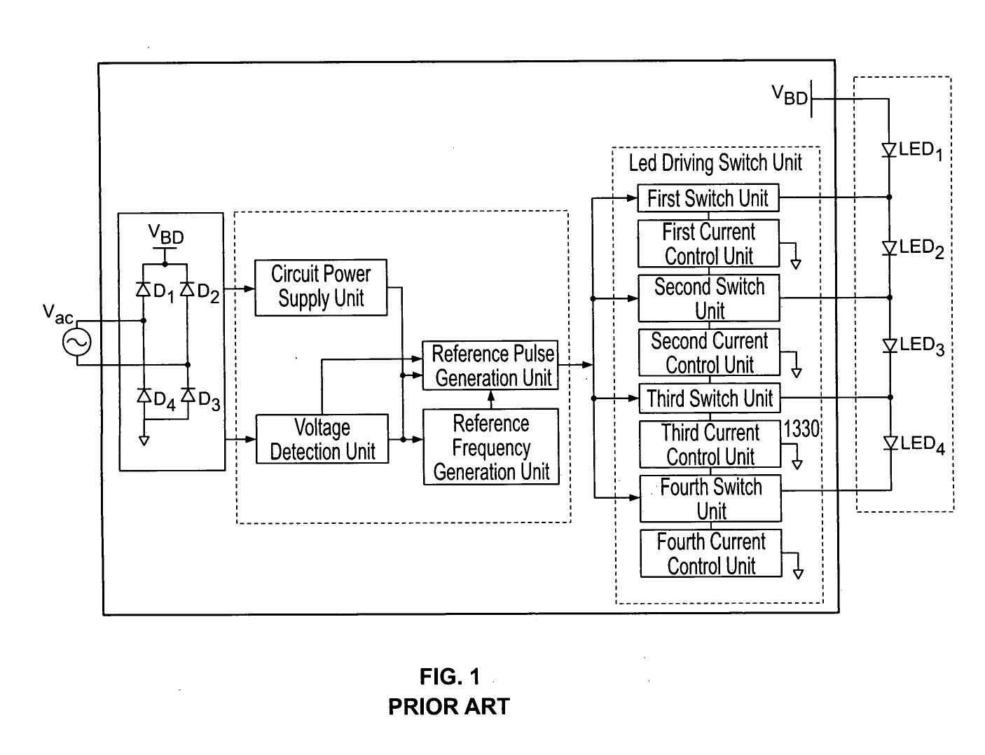

FIG. 2 is a diagram showing a complete power line cycle for the operation of a light engine having four LED strings each with a switchable constant current drive associated.

FIG. 3 is a first embodiment of a light engine according to the present invention.

FIG. 4 shows the current drawn from the AC power line by the first embodiment of the light engine according to the present invention.

FIG. 5 shows the current dawn from the AC power line by the preferred embodiment of the light engine according to the present invention.

The call out list of elements can be a useful guide in referencing the elements of the drawings.
101 first LED string
102 second LED string
103 third LED string
104 fourth LED string
105 LED1
106 LED16
107 MOSFET Q1
108 LED17
109 LED32
110 MOSFET Q2
111 LED33
112 LED48
113 MOSFET Q3
114 LED49
115 LED64
116 MOSFET Q4
116A diode D1
117 diode D2
118 diode D3
119 diode D4
120A rectified DC voltage V3
121 VCC
122 low power reference voltage V2
123 resistor R1
124 resistor R2
125 reference voltage Vref
126 operational amplifier (opamp) U1
127 operational amplifier (opamp) U2
128 operational amplifier (opamp) U3
129 operational amplifier (opamp) U4
130 RS1
131 RS2
132 RS3
133 RS4
134 feedback resistor R1_1
136 feedback resistor R1_2
137 feedback resistor R2_2
138 feedback resistor R1_3
139 feedback resistor R2_3
140 feedback resistor R1_4
141 feedback resistor R2_4

### DETAILED DESCRIPTION OF THE INVENTION

### a) Basic Embodiment

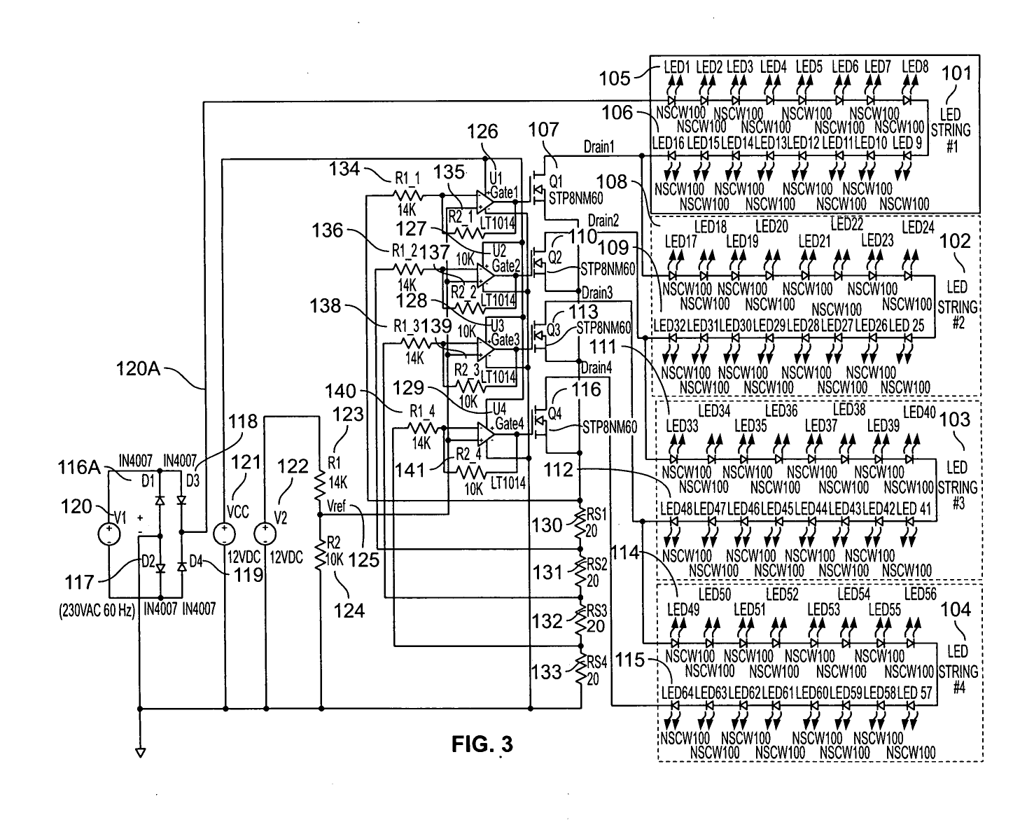

FIG. 3 shows the arrangement of a constant current ac driven light engine with four strings of LEDs. This AC LED Driver operates the LEDs in constant current mode. In each step of operation through the AC power line cycle the LEDs are operated at a relatively constant current, although that current is increased and decreased through the power line cycle in order to follow the sine wave input voltage waveform as is required to produce good power factor. The power grid input in this case is 230 VAC @60 Hz. However, the same principle applies to other voltages from 90 VAC to 382 VAC, and 47 Hz to 63 Hz applications.

The 4 steps of operation during a power line voltage half wave of operation involve sequentially turning on the 4 strings of LED's, namely LED string #1 (101), LED string #2 (102), LED string #3 (103) and LED string #4 (104). In this embodiment, each LED string has 16 LED's in series with the cathode of each connected to the anode of the next. LED string #1 (101): LED1 (105) to LED16 (106) are connected in series, and driven by MOSFET Q1 (107). LED string #2 (102): LED17 (108) to LED32 (109) are connected in series, and driven by MOSFET Q2 (110). LED string #3 (103): LED33 (111) to LED48 (112) are connected in series, and driven by MOSFET Q3 (113). LED string #4 (104): LED49 (114) to LED64 (115) are connected in series, and driven by MOSFET Q4 (116).

All these LED strings are further connected by connecting cathodes to anodes between LED16 (106) and LED17 (108), LED32 (109) to LED33 (111), LED48 (112) and LED49 (114). The power grid AC voltage is full wave rectified by a bridge rectifier arrangement consisting of diodes D1 (116A), D2 (117), D3 (118) and D4 (119) which in this embodiment were part number 1N4007. No electrolytic capacitors are used. The rectified DC voltage V3 (120A) has high ripple (almost 100%) without any “filtering capacitor”. However, small value, extremely long life, ceramic capacitors may be used to construct the low voltage, low power source VCC (121) for the opamp which is 12 VDC in this illustrative embodiment, and the low voltage low power reference voltage V2 (122) which is also 12 VDC. These low power voltages are merely illustrative and many different voltages could be used. The details of the low power VCC (121) and V2 (122) voltage regulator circuits are omitted here, and for clarity just two voltage sources are shown.

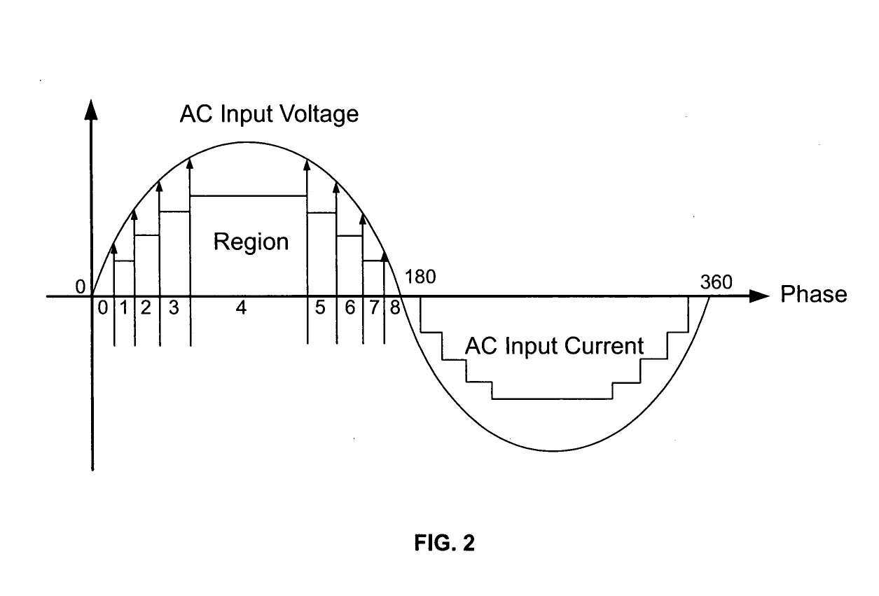

In the this embodiment the 64 LEDs in the 4 strings are Nichia part number NSCW100 white LED with a typical forward voltage Vf of 3.6 VDC and a maximum forward voltage of 4.0 VDC at a forward current If of 20 mA. With suitable adjustments to the circuit, any LED could be used. The AC input voltage V1 (120) in this embodiment is 230 VAC, although obviously any line voltage could be used with suitable adjustments to the circuit. The number of LEDs in each LED string is 16. The key advantage of driving the LEDs with constant current is to prolong the usable life of the LED by preventing excess power dissipation. Brand new parts of Nichia NSCW100 usually have a forward voltage of 3.6V and it gradually increases to 4.0V near the end of life. The peak voltage of 230 VAC is 1.414×230V=325V. We need to divide 325V into 5 levels as shown in FIG. 2 for region 0, 1, 2, 3 and 4. Each level is about 64V. 16 LEDs are used in each string. When the LED are brand new with Vf=3.6 VDC, the voltage steps are 16×3.6V=57.6V. When the LEDs are aged close to the end of life, the voltage steps are increased automatically (due to constant current driving technology) to 16×4.0V=64V.

The V2 (122) voltage is divided by 2 resistors R1 (123) and R2 (124) to provide the reference voltage Vref (125). Vref=V2×R2/(R1+R2). The Vref (125) voltage is connected to the quad opamp “+ input” pins to make an automatic feedback loop controlling the LED current. The V2 (122) voltage and R1 (123), R2 (124) values can be adjusted in order to set the overall current level provided by the current limiters comprised by MOSFETs Q1 (107), Q2 (110), Q3 (113) and Q4 (116). The “− input” pins of the opamps are connected to the four respective sense resistors which enables the control of the current through the LED strings as described below. For this reason the “− input pins” are referred to as the control terminals of the current limiters.

For properly selected R1 (123)=14K and R2 (124)=10K, the Vref (125) is about 5.0 VDC, which is the minimum gate voltage for MOSFETs Q1 (107), Q2 (110), Q3 (113) and Q4 (116) to start conducting in the “linear region” where the LED current is in the constant current mode. When the MOSFETs Q1 (107), Q2 (110), Q3 (113) and Q4 (116) are turned ON in the “linear region”, the MOSFET Gate Voltage is about 7 VDC to 8 VDC. If the gate voltage is above 8.5 VDC, the MOSFET will be fully saturated resulting in loss of current control.

### THE Feedback Mechanism to Produce Constant Current:

The resulting power line input current of this and other multi segment direct AC driven constant current LED light engines is shown in FIG. 2. In FIG. 2 region 0, the instantaneous voltage from the bridge rectifier is too low for LED strings #1, #2, #3 and #4 (101, 102, 103 and 104) to conduct current. There is no current flowing through sense resistors RS1, RS2, RS3 and RS4. The feedback voltage on the “−input” pin of each of the four operational amplifiers (opamps) U1, U2, U3 and U4 (126, 127, 128 and 129) is lower than the “+ input” voltage which is fixed at 5 VDC. The gate terminal voltage on all of the MOSFETS Q1, Q2, Q3 and Q4 (107, 110, 113 and 116) is greater than 8.5 VDC, and they are all fully turned ON.

In FIG. 2 region 1, MOSFET Q1 (107) is turned ON in its “linear region” and Q2, Q3 and Q4 (110, 113 and 116) are turned ON but the voltage from the bridge rectifier is too low for LED string #2 #3 and #4 (102, 103 and 104) to conduct current. The current through LED string #1 (101) (ILED1) goes through MOSFET Q1 (107), then goes through RS1, RS2, RS3 and RS4 (130, 131, 132 and 133) in series. The voltage at the top side of RS1 which=ILED1×(RS1+RS2+RS3+RS4), is fed back to opamp U1 (126) “− Input” pin via feedback resistor R1_1 (134). In addition, there is another feedback resistor R2_1 (135) connecting from the U1 (126) output pin to U1 (126) “− Input” pin. This feedback mechanism regulates ILED1 at the desired level until LED string #2 starts up.

In FIG. 2 region 2, MOSFET Q2 (110) is turned ON in its “linear region”, Q1 (107) is turned OFF because of the excessive voltage now present across its sense resistor RS1 (130) and Q3 and Q4 (113 and 116) are turned ON although the output voltage from the bridge rectifier is too low for LED strings #3 and #4 (103 and 104) to conduct current. The bridge rectifier output voltage is high enough for LED strings #1 and #2 (101 and 102) in series to conduct current. The LED string #1 (101) current ILED1 is identical to the current through LED string #2 (102) ILED2. LED string #2 (102) current ILED2 is going through MOSFET Q2 (110), then goes through RS1, RS2, RS3 and RS4 (130, 131, 132 and 133) in series. The voltage on the top side of RS2 which=ILED2×(RS2+RS3+RS4), is fed back to the opamp U2 (127) “− Input” pin via a feedback resistor R1_2 (136). In addition, there is another feedback resistor R2_2 (137) connecting from U2 (127) output pin to U2 (127) “−Input” pin. This feedback mechanism regulates ILED2 at the desired level until LED string #3 starts up.

In FIG. 2 region 3, MOSFET Q3 (113) is now turned ON in its “linear region”, Q1 and Q2 (107 and 110) are turned OFF by the excess voltage present at the tops of RS1(130) and RS2(131) respectively and Q4 (116) is turned ON but the bridge rectifier output voltage is too low for LED string #4 (104) to conduct current. The bridge rectifier output voltage is high enough for LED strings #1 #2 and #3 (101, 102 and 103) in series to conduct current. The current through LED strings #1 and #2 (101 and 102) is identical to the current ILED3 through LED string #3 (103). The LED string #3 (103) current ILED3 goes through MOSFET Q3 (113), then through RS1, RS2, RS3 and RS4 (130, 131, 132 and 133) in series. The voltage at the top side of RS3 which=ILED3×(RS3+RS4), is fed back to opamp U3 (128) “− Input” pin via the feedback resistor R1_3 (138). In addition, there is another feedback resistor R2_3 (139) connecting from U3 (128) output pin to U3 (128) “− Input” pin. This feedback mechanism regulates ILED3 at the desired level until LED string #4 starts up.

In FIG. 2 region 4, MOSFET Q4 (116) is turned ON in its “linear region”, Q1 Q2 and Q3 (107, 110 and 113) are turned OFF by the excess voltage at the tops of RS1(130), RS2(131) and RS3(132) respectively. The bridge rectifier output voltage is high enough for LED strings #1 #2 #3 and #4 (101, 102, 103 and 104) in series to conduct current. The current through LED strings #1 #2 and #3 (101, 102 and 103) is identical to the current ILED4 in LED string #4 (104). The current ILED4 through LED string #4 (104) goes through MOSFET Q4 (116), then goes through RS1, RS2, RS3 and RS4 (130, 131, 132 and 133). The voltage at top side of RS4 which=ILED4×RS4, is fed back to opamp U4 (129) “− Input” pin via a feedback resistor R1_4 (140). In addition, there is another feedback resistor R2_4 (141) connecting from U4 (129) output pin to U4 (129) “− Input” pin. This feedback mechanism holds ILED4 at the desired constant level regardless of the input voltage.

In the foregoing description of the bridge rectifier output voltage rising from 0 to peak, all four MOSFETs were turned ON in region 0 but there was no current going through them because the voltage was lower than LED forward voltages of the four LED strings. In region 1, only LED string #1 (101) is turned ON in constant current mode with LED string #1 (101) current=ILED1, controlled by 4 sense resistors in series (RS1+RS2+RS3+RS4). In region 2, LED string #1 and #2 (101 and 102) are turned ON in constant current mode, with ILED1=ILED2, controlled by only 3 sense resistors (RS2+RS3+RS4). Therefore, LED string #1 (101) is conducting current in both region 1 and region 2. Due to the 3 sense resistors having total series resistance lower than all 4 sense resistors, the ILED2 current in region 2 is greater than the ILED1 current in region 1. Therefore, the LED string #1 has ILED1 current in region 1, and ILED2 current in region 2. The LED string #1 (101) current is stepping upward in the same manner in region 3 and region 4. The same calculation gives the relation ILED4>ILED3>ILED2>ILED1. This is the basic principle for the staircase like LED current waveform in this AC LED light engine. The LED string #1 (101) has 4-steps going up from region 0 to region 4. LED string #2 (102) has 3-steps going up from region 1 to region 4. LED string #3 (103) has 2-steps going up from region 2 to region 4. LED string #4 (104) transitions from zero current to current ILED4 in region 4.

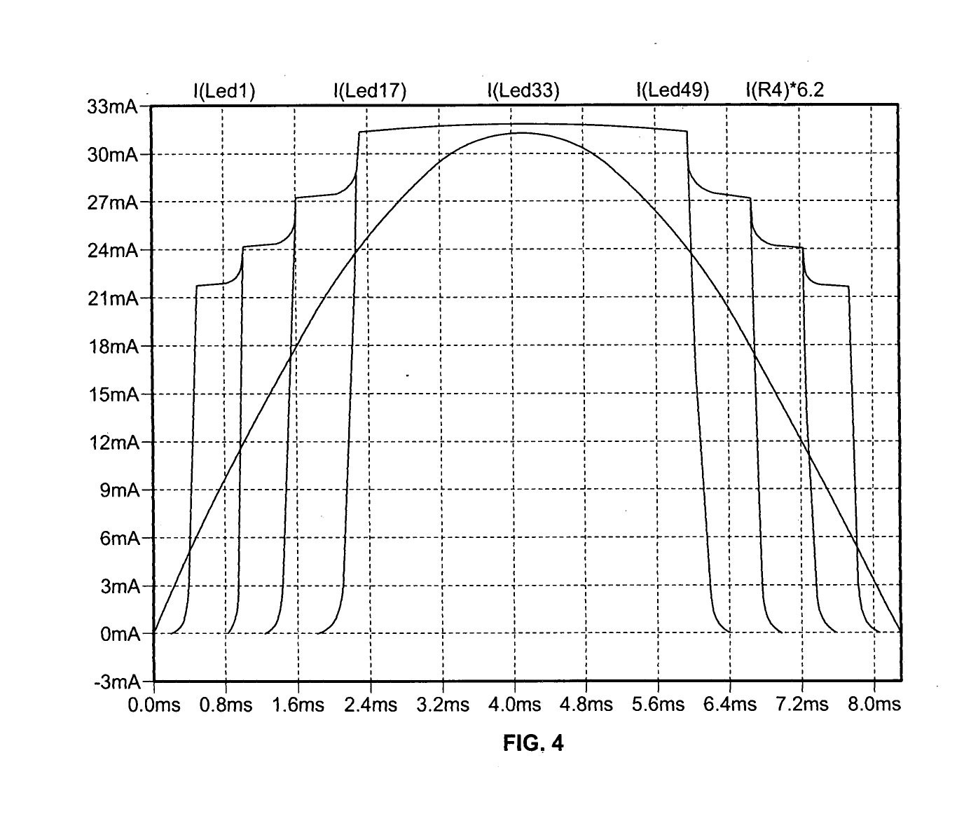

When the AC voltage reaches the peak at the center of region 4, or at AC Phase 90 degrees, it starts falling. In region 5, 6 and 7, the LED strings follow the same principle as in regions 3, 2 and 1 with the same values of ILED3, ILED2 and ILED1. Finally in region 8, the AC voltage is too low and none of the LEDs conducts any current. In FIG. 4 the currents of LED strings #1 #2 #3 and #4 (101, 102, 103 and 104) are shown at 22 mA, 24 mA, 28 mA and 32 mA respectively with 4, 3, 2 and 1 steps. The phase of the voltage half wave between 0 and 180 Degrees is shown for reference. It can be seen that proportionately the current drawn from the power line rises faster than the power line voltage, leading to excessive current harmonic distortion.

### b) Preferred Embodiment with Improved THD Performance

As just remarked above, the simplistic embodiment in which all four R1 resistors have the same value of 14K leads to the current waveform not following well the voltage waveform. In the preferred embodiment the four R1 resistors are adjusted so that the 4 steps of LED current will closely follow the AC voltage sine wave contour making possible low current total harmonic distortion.

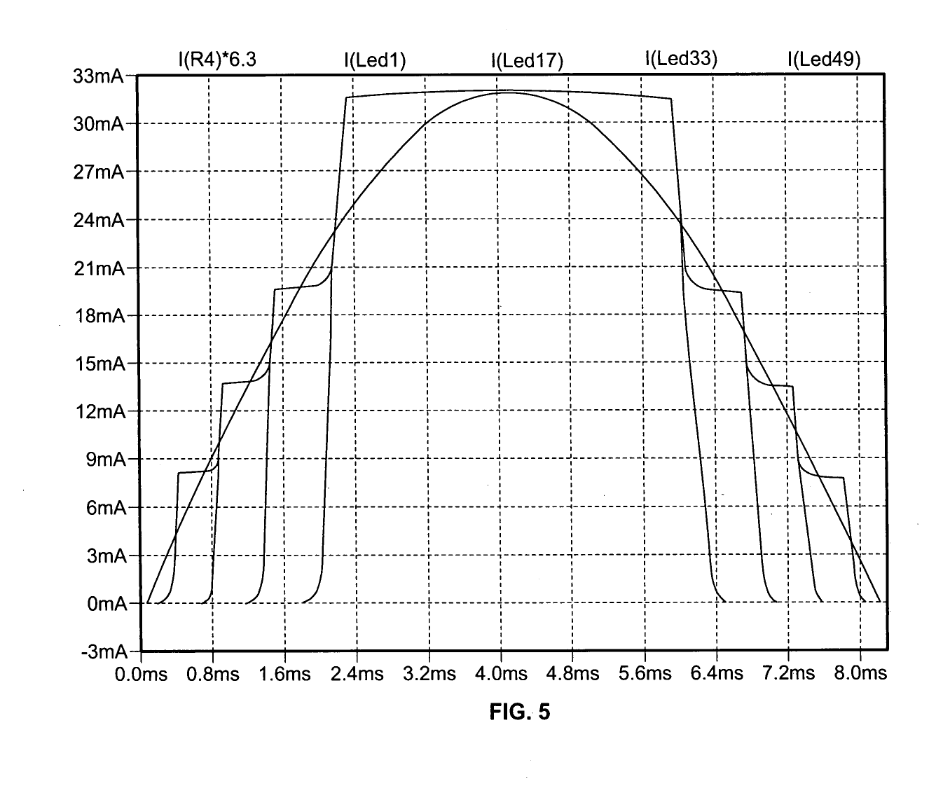

The three resistors R1_1 (134), R1_2 (136) and R1_3 (138) which were originally all 14K Ohm are changed to 39K, 22K and 16K Ohm respectively. FIG. 5 shows the AC power line current with these 3 new resistors. The 3 flat LED current readings are now at 8 mA, 14 mA and 20 mA which coincide with the AC Sine wave contour. These modified resistor values produce significantly improved current total harmonic distortion.

Although specific components have been described in the above embodiments for illustrative purposes, those skilled in the art will be able to immediately see numerous variations of the invention using different components and ratios. Even though four LED strings were described, the principles of the invention can be applied to any number of LED strings. The strings described had 16 LEDs each, however with different power line voltages and new LED technology essentially any number of LEDs could be present in a string. The strings depicted had equal numbers of LEDs, however it could be advantageous under certain circumstances for the strings to have unequal numbers of LEDs. Single LEDs were depicted in the strings, however under some circumstances packages with two or more LEDS could be used advantageously. Although light emitting diodes were described, any device which emits light with the application of an electric current could be used. The switches were described as being n-channel silicon MOSFETS, however IGBTs, bipolar transistors and any of the numerous solid state switches known to those of skill in the art could be used. Discrete silicon diodes were described for the bridge rectifier function, but any kind of diode, including light emitting diodes, could be used and the bridge rectifier might be formed from a single integrated package. Any of the resistors and current limiters described could be replaced by constant current resistors or other active devices while following the same principles. Capacitors could be added to store energy to prevent a dark period around the line voltage zero crossing time. The exemplary circuit described operated at 230V, however the principles of the invention could be applied to circuits operating at any of the standard world utility voltages, such as 90V, 120V, 220V, 240V, 277V and 347V.

Accordingly it will be apparent to those skilled in the art that many modifications and variations can be made in the present invention without departing from the spirit or scope of the invention. Thus it is intended that the present invention cover the modifications and variations of this invention provided they come within the scope of the appended claims and their equivalents.

1) An LED light engine connected to the AC power line through a bridge rectifier means comprising:
a. AC input terminals;
b. positive and negative output terminals;
c. LEDs that are all connected together anode to cathode in a series string, with an anode end of the series string connected to a bridge rectifier positive output terminal and the series string being structured into a plurality of substrings, each substring having a constant current circuit connected from its cathode end to the end of a corresponding string of current sense resistors, wherein each sense resistor corresponds to constant current circuits and all connected in series between the constant current circuits and the negative terminal of the bridge rectifier.

2) The LED light engine of claim 1, wherein the constant current circuits are each comprised of a power mosfet driven by an op-amp with a constant current circuit input connected to a corresponding sense resistor.

3) The LED light engine of claim 1, in which each consecutive current limiter is respectively controlled by a corresponding consecutive sense resistor, said resistors connected to each other in series with the first sense resistor having its positive end connected to the negative ends of all the current limiters and to the control terminal of the first current limiter and each successive sense resistor having its positive end connected to the control terminal of the corresponding current limiter and the negative end of the previous sense resistor; the last sense resistor having its positive end connected to the control terminal of the last current limiter and its negative end connected to the negative terminal of the bridge rectifier.

4) The LED light engine of claim 3, in which there is provided a reference voltage source connected for reference purposes to each of the current limiters in order to define the limiting current of the current limiter.

5) The LED light engine of claim 4, wherein there are at least 2 steps of the constant current driving method.

6) The LED light engine of claim 5, wherein there are at least 3 steps of the constant current driving method.

7) The LED light engine of claim 6, wherein there are at least 4 steps of the constant current driving method.

8) The LED light engine of claim 4, wherein a loop gain of MOSFETs Q1 (107), Q2 (110), Q3 (113), and Q4 (116) is configured to be adjustable by varying resistor values of R1_1, R1_2, and R1_3 to allow LED current waveform follow the AC Sine wave contour closely to improve AC input current total harmonic distortion (THD).
